(19) United States
(12) Patent Application Publication
(10) Pub. No.: US 2011/0179714 A1
(43) Pub. Date: Jul. 28, 2011

(54) PROCESS FOR THE PURIFICATION-SWEETENING OF NATURAL GAS BY MEANS OF CONTROLLED DISSOCIATION OF HYDRATES AND USE THEREOF AS SEPARATORS

(75) Inventors: Carlo Giavarini, Roma (IT); Filippo Maccioni, Roma (IT)

(73) Assignee: UNIVERSITA' DEGLI STUDI DI ROMA "LA SAPIENZA", Roma (IT)

(21) Appl. No.: 13/058,807

(22) PCT Filed: Aug. 10, 2009
(86) PCT No.: PCT/IT09/00376

§ 371 Date: Apr. 1, 2011

(30) Foreign Application Priority Data
Aug. 14, 2008 (IT) RM2008A000462

(51) Int. Cl. C01B 3/32

(52) U.S. Cl. 48/127.5

(57) ABSTRACT

The invention concerns a process for reducing and/or removing sour gases, such as carbon dioxide and hydrogen sulfide, from natural gas or from gas associated with oil reservoirs, by means of the formation of mixed hydrates, wherein a selective separation is carried out both during the hydrates decomposition, under pressure conditions close to atmospheric pressure and temperatures little below zero, and, preferably, during a preliminary step, with pressures and temperatures close to the equilibrium values.

The present invention concerns a process for purifying-sweetening natural gas by means of controlled dissociation of hydrates (clathrates) and the use of such hydrates as separators. More specifically, the invention concerns a process for separating and/or removing sour gases, such as carbon dioxide and hydrogen sulfide, from natural gas or from the associated gas in petroleum reservoirs, through the formation of mixed hydrates, wherein the selective separation takes place both during the hydrates decomposition, under pressure conditions close to atmospheric pressure and temperatures little below zero, and, thereafter, under pressures and temperatures close to equilibrium values.

Natural gas and gas associated with oil reservoirs have become, in the latest years, a strategic energy reserve alternative to conventional energy sources, such as coal and crude oil. Natural gas coming from production sites essentially consists of methane, but also contains higher hydrocarbons (from C₂ to C₅₊), and, in addition, variable percentages of inert or polluting gases (such as carbon dioxide and hydrogen sulfide) and water. These components, that are normally found in the gaseous phase, must be reduced or removed in order to comply with the pipeline specifications. Such specifications indicate, as concerns hydrogen sulfide (also known as sulfurated hydrogen), a concentration close to zero.

On the other hand, the latest discoveries of natural gas reservoirs increasingly evidence the presence of remarkable amounts of hydrogen sulfide and carbon dioxide together with methane.

The international scientific literature reports various methods for removing polluting and inert substances from natural gas. Most of these processes, that are normally effective but not always cheap, are based on cryogenic removal (such as in the case where nitrogen is the main substance to be removed) or on absorption on alkanolamine solutions (such as in the case of hydrogen sulfide removal).

As concerns, specifically, hydrogen sulfide, there exist natural gas reservoirs in the world where the concentration of such pollutant is so high that the exploitation of the reservoir and the connected gas purification turn out to be economically inconvenient or practically unfeasible.

Further, it is to be noted that the exploitation of these natural gas reservoirs is also often discontinued as a result of build-up of hydrates at the well head, which give origin to real obstructions, blocking the gas exit.

As it is known, gas hydrates (or gas clathrates) are solid crystalline compounds that form when water combines with small molecules (generally gases), normally at temperatures close to zero and high pressures. Molecules that may form hydrates include not only hydrocarbons such ad methane, ethane and propane, but also carbon dioxide, hydrogen sulfide and nitrogen. When forming the hydrate, water crystallizes in a clathrate structure, i.e., as an inclusion complex where small size molecules (former) are trapped in a cage-like lattice structure formed by hydrogen bonded molecules. It is evident that in the pressure and temperature conditions that are found in many natural gas drilling wells, the possibility that gas hydrates are formed at the well head is generally considered to be nothing but a source of problems.

In the latest years, however, some alternative methods of purifying natural gas have been presented that are actually based on clathrate hydrates formation (see, e.g., Keens D.; Sathananthan R.; Natural gas sweetening with minimum gas loss. Institution of chemical engineers symposium series (72), 1-13, 1998). Specifically, such proposals exploit the possibility of separating the compounds of interest based on their different tendency to form hydrates.

For instance, Hnatov et al. (U.S. Pat. No. 5,434,330 to M. A. Hnatov and J. Happel) describe a method purifying natural gas from nitrogen, carbon dioxide and hydrogen sulfide through the formation of gas hydrates with a precooled aqueous solution of methanol. Coming into contact with said solution, the natural gas forms hydrates, thus separating from the polluting gases (which increase in concentration in the gaseous stream), and is then recovered from the hydrates suspension by thermal dissociation. Such prior art document, however, does not take into account any practical examples where the pollutant is mainly hydrogen sulfide; further, it is to be noted that the use of methanol introduces some complexity in the process and may give rise to environmental concerns.

The international patent application publ. No. WO2006/002781 (Ciccarelli L. G. and Borghi G. P.) discloses a further method for purifying natural gases by means of hydrates. In this case thermodynamic conditions suitable only to the formation of hydrogen sulfide hydrates are used, the latter being separated by sedimentation. The document further teaches to operate on the hydrogen sulfide hydrates by a thermal dissociation, and to recycle the resulting aqueous solution in the same natural gas field or in suitable geological structures. The technological proposal disclosed, however, does not take into account the phenomenon of hydrates formation promotion that the hydrogen sulfide and carbon dioxide hydrates exert on the formation of clathrates of natural gas light components. Actually, the cited document only considers the thermodynamics of the process and does not consider that in a gaseous mixture the hydrates formation occurs between water and all the “former” molecules present in the mixture.

Actually, as it is shown by the literature data, gases such as H₂S and CO₂ promote the formation of mixed hydrates of natural gas at lower pressures and higher temperatures than the pressures and temperatures typical of each gas individually taken (Sun C. Y., Chen G. J., Lin W. and Guo T. M.; “Hydrate formation conditions of sour natural gases”, J. Chem. Eng. Data, 2003, 48, 600-602). Therefore, when carrying out a process such as that disclosed in WO2006/002781 a partial separation of gas would be obtained, but such separation would not be such as to justify a process effective on an industrial scale.

In the light of the foregoing, it appears that the very few proposals made up to now in the scientific literature concern the possible separation of sour gases by hydrates formation directly from natural gas and that by operating in this way, however, mixed hydrates are formed and an effective separation is not achieved.

In the frame of the studies that brought to the present invention, it has been found that it is possible to carry out a new method, different and cheaper with respect the previous ones, which is substantially based on a controlled dissociation of hydrates both under atmospheric pressures and under thermodynamic conditions close to equilibrium. Such method is based on the combined separation effect that takes place, in part, during the hydrates formation and, mostly, during the dissociation of the same or in conditions close to dissociation.

The controlled dissociation of hydrates under low pressures ad proposed according the invention is based on a purification process of a natural gas containing significant concentrations of carbon dioxide and hydrogen sulfide. These sour gases tend to favor the hydrates formation, which may be effected at temperatures and pressures much less severe than those characterizing pure methane. According to the invention, it has been found that once a solid solution of mixed hydrates has been obtained, it is possible to obtain a separation by acting only on the operating pressure or on the operating temperature.

Such separation procedure may also be applied in the case that the well head is plugged; it is possible to act on the “plug” formed, by mildly dissociating the mixed hydrate, thus obtaining a first separation upstream of the first classical separation processes.

Therefore, the present invention specifically provides a process for purifying-sweetening natural gas through the controlled dissociation of the corresponding hydrates, which process comprises, in a sequence, the following steps:
a) forming hydrates of a natural gas, having concentrations of H₂S and CO₂ of from 10 ppm to 40% by volume, in a reactor and with the addition of water, if not already present in the feedstock, to obtain a first separation step during the formation of the said hydrates;
b) downloading from said reactor and separating the gas remaining from step a) which did not form hydrates;
c) purifying the hydrates formed in the previous steps by dissociation of the H₂S hydrates under pressure conditions above 0.1 MPa and at temperatures comprised between 0° C. and −5° C., to obtain a second separation step during the dissociation of the said hydrates formed in step a);
d) downloading the gas produced by the controlled dissociation of step c), enriched in H₂S;
e) obtaining fast dissociation of the hydrates remaining from step d), containing hydrocarbon compounds.

Preferably, the claimed process also comprises, further to said step e), the following step:
f) recovering the reaction water and recycling it for another sequence of the procedure of hydrates formation from natural gas.

According to some preferred embodiments thereof, in the proposed process said step a) of hydrates formation is carried out in a batch reactor in the presence of water or with water in the feedstock.

The procedure proposed according to the invention may also be advantageously applied by carrying out, before the operating steps referred to before, a preliminary procedure of “reformation-concentration” of the methane hydrates in the solid phase (which will be described in more detail with reference to the operating Examples) by carrying out a thermodynamic cycle close to the equilibrium curve, with venting of the unreacted sour gas downstream the said “reformation-concentration” procedure, comprising, after the steps a) and b), the following steps:
A. forming hydrates of a natural gas, having concentrations of H₂S and CO₂ of from 10 ppm to 40% by volume, in a reactor containing therein an already formed hydrate, under pressures and temperatures close to the equilibrium pressure and temperature, to obtain a methane-enriched mixed hydrate and, possibly, light hydrocarbons, and a remaining gas consisting of H₂S and CO₂;
B. downloading from said reactor, and separating, the remaining gas from step A) which did not form hydrates, consisting of H₂S and CO₂;
   the remainder of the process being analogous to steps c) and following as defined above.

According to some preferred solutions, in the last described process the said steps A) and B) are cyclically repeated two or more times.

According to another possible solution, which will be better described in the examples, in the process according to the invention said “reformation-concentration” procedure is carried out under constant pressure, with continuous hydrate formation.

In the proposed process, as in other processes of the same field, conditioning agents suitable to favour the hydrates formation are preferably mixed in the process reaction water, said agents being selected from the group consisting of quaternary ammonium salts, phosphonium salts, mixtures of clayey aggregates containing kaolin and montmorillonite.

Also coformer agents, suitable to favour the hydrates formation process, may be added in the reaction water. The said agents may be, for example, tetrahydrofurane (THF), cyclopentane or mixtures thereof.

Further, according to some embodiments of the invention, other compounds suitable to interfere with the hydrogen bond may be added in the reaction water, these compounds being preferably selected from the group consisting of glycols and alcohols.

Another optional technological solution, finally, is that of employing, two or more reactors working in parallel, in order to assure the continuity of the process.

By preference, the latent heats during the fast dissociation of the purified hydrates are exploited to obtain a heath exchange in the course of the process.

The specific features of the invention, as well as its advantages and the relevant operating modes, will be more evident with reference to the detailed description presented for merely exemplificative purposes in the following, together with the results of the experimentation carried out on it and a comparison with the prior art. Some of the experimental results are also illustrated in the enclosed drawings, wherein:

FIG. 1 shows the dissociation rate (in % mol/sec) of hydrogen sulfide hydrates (H2S), of carbon dioxide hydrates (CO2) and methane hydrates (CH4) at 0.2 MPa in the experimental conditions of the second part of the process according to the invention described in Example 1;

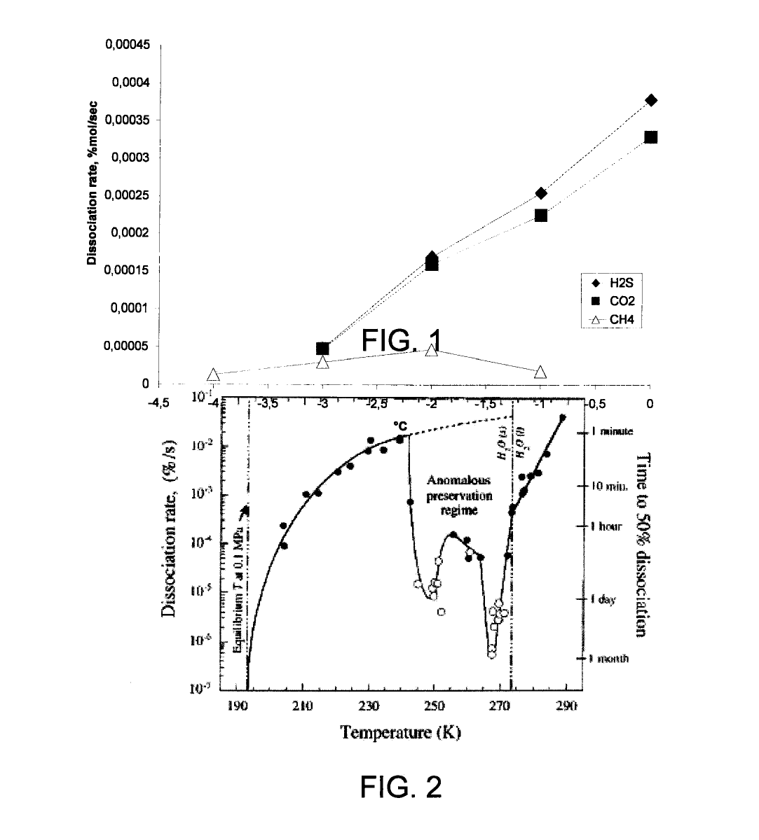

FIG. 2 is a diagram taken from the known literature, showing the “self-preservation” effect in the dissociation of methane hydrates at atmospheric pressure and temperatures little below 0° C.;

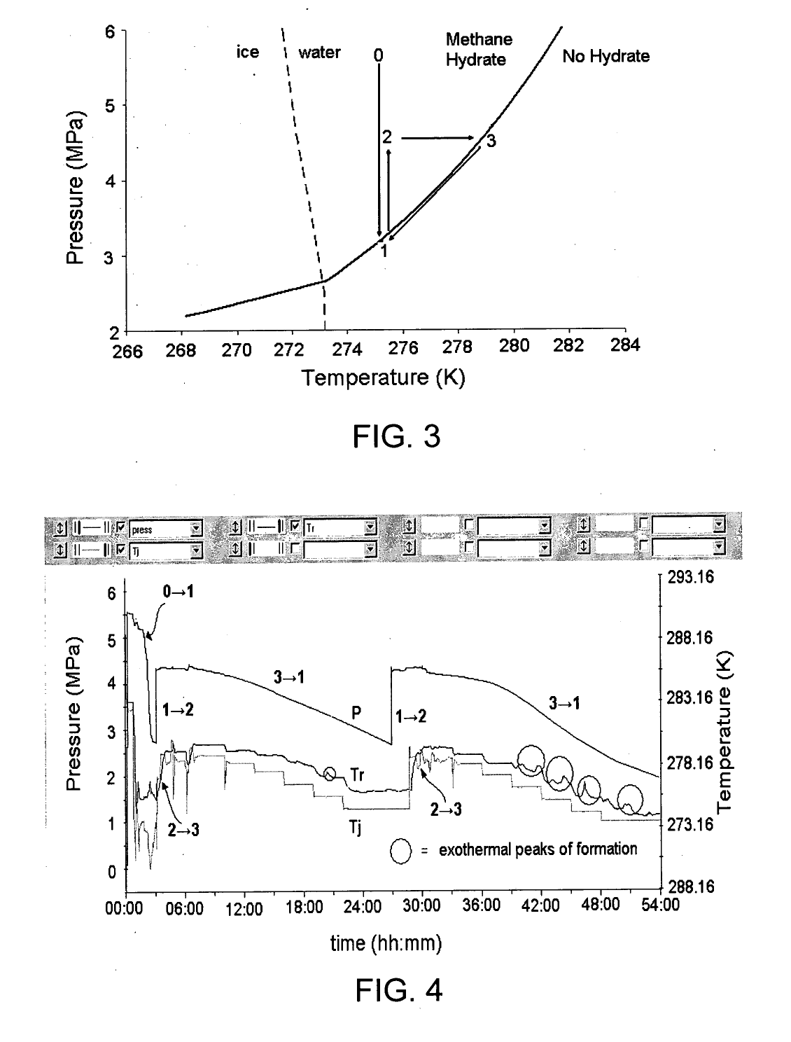

FIG. 3 is a diagram taken from the most recent literature, showing the “reformation-concentration” cycle of methane hydrates, at temperatures little above 0° C. close to the equilibrium curve on the P-T plane;

FIG. 4 is a diagram taken from the same literature, showing the experimental behavior of the “reformation-concentration” cycle of methane hydrates;

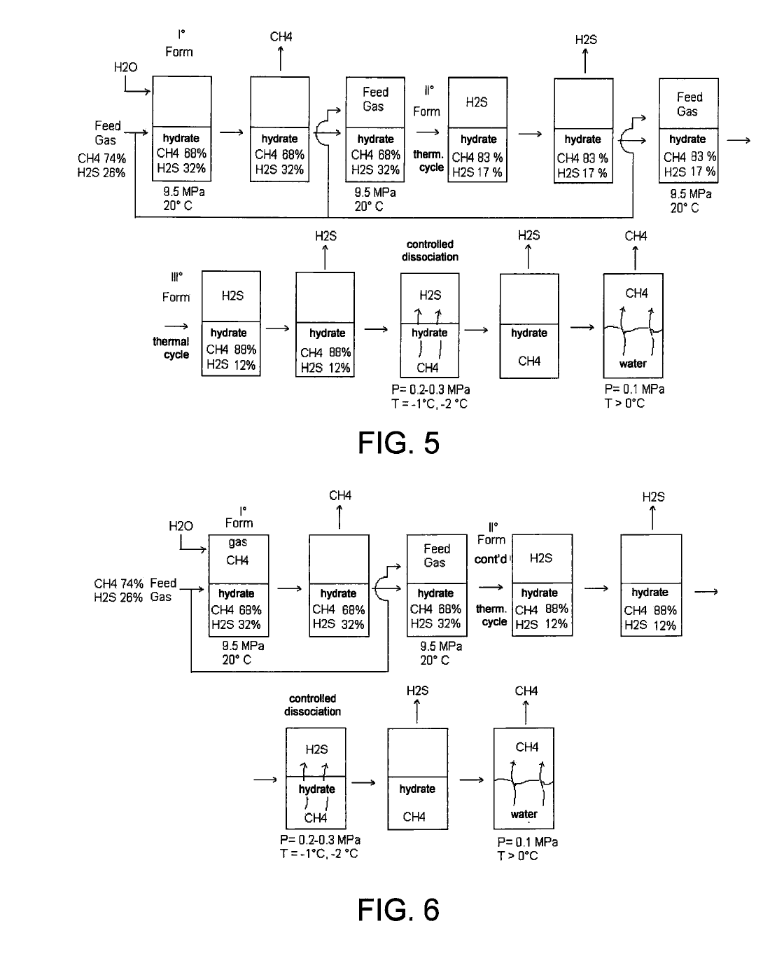

FIG. 5 is a simplified block diagram of the process according to the invention, in the embodiment described in Example 2; and

FIG. 6 is a simplified block diagram of the process according to another embodiment of the invention, as described in Example 3.

### EXAMPLE 1

### Separation of Sour Gases by Controlled Dissociation at Low Pressures and Temperatures Little Below 0° C.

Considering a natural gas at the pressure of 2 MPa and having the average composition shown below:

| | | | |
|---|---|---|---|
| Methane | CH₄ | 70.0 | (% mol) |
| Ethane | C₂H₆ | 4.3 | (% mol) |
| Hydrogen sulfide | H₂S | 15.0 | (% mol) |
| Carbon dioxide | CO₂ | 10.0 | (% mol) |
| Others | | 0.7 | (% mol) |

In a closed reactor kept under 2 MPa (20 bar) of pressure and at 1° C. of temperature, 8000 Nm³ of the above gaseous mixture are introduced, together with an amount of 15 t of water (which may be fed both as a liquid or in the nebulized form).

The contact between water and gas produces 18.4 t of hydrate. The hydrate formed has a mixed composition containing higher percentages of sour compounds (CO₂, H₂S), which are formed in less severe thermodynamic conditions, and lower concentrations, with respect to the sour compounds, of methane and other higher hydrocarbons (first separation).

Practically, the transformation of the sour components (H₂S and CO₂) from gaseous to solid (hydrate) is complete, with a yield close to 100%.

The remaining gas which did not form hydrates substantially consists of light hydrocarbons (methane and ethane in this case), and is extracted from the reaction chamber and sent to storage or to the use thereof.

The hydrate present in the reactor, containing methane, carbon dioxide and hydrogen sulfide, is depressurized to 0.1-0.2 MPa and kept at a temperature from −1° C. to −2° C. In these conditions, the decomposition rate of hydrates containing hydrogen sulfide and carbon dioxide is about three times the decomposition rate of hydrates containing methane or other light hydrocarbons. The final separation of H₂S and CO₂, thus, occurs at this stage (second separation stage during the dissociation).

Once the dissociation of sour hydrates is over, the conditions suitable for methane hydrates dissociation are created (T>0° C. and P=0.1 MPa). The purified gas (methane and ethane) is thus sent to storage or to its use.

In order to better understand the meaning of separation during the dissociation, FIG. 1 of the enclosed drawings reports in a diagram the dissociation rate of hydrates containing hydrogen sulfide and methane at 0.2 MPa of pressure and at temperatures in the range from −4° C. and 0° C. From the latter it appears that the dissociation rate is higher for the hydrogen sulfide clathrates.

The above behavior derives from the so-called self-preservation” properties shown by the methane hydrates in the above conditions, as it has already been reported in the scientific literature (Stern, L., Circone, S., Kirby, S., Durham, W.; Anomalous preservation of pure methane hydrate at 1 atm. J. Phys. Chem. B 2001, 105, 1756; Giavarini C., Maccioni F.; Self-Preservation at Low Pressures of Methane hydrates with Various Gas Contents. Industrial Engineering Chemistry Research, 43, 6616-6621, 2004). The effect of “self preservation” of methane hydrates in the dissociation under different temperature conditions is shown, for an immediate reference, in FIG. 2 of the enclosed drawings.

Another way (besides exploiting the self-preservation of methane) to obtain a selective separation of sour gases through controlled dissociation of hydrates that is considered according to the present invention is connected with the phenomenon of “reformation-concentration” of methane hydrates in thermodynamic conditions close to the equilibrium conditions. As it has been reported by the same authors of the present invention (Giavarini C., Maccioni F.; Formation and dissociation of CO₂ and CO₂-THF hydrates compared to CH₄ and CH₄-THF hydrates; Proc. of 6^{th} Intl. Conf. on Gas Hydrates. Vancouver BC, Canada 6-10 Jul. 2008; Giavarini C., Maccioni F.; A High Yield Process for Bulk Hydrate Formation; Proc. of 6^{th} Intl. Conf. on Gas Hydrates. Vancouver BC, Canada 6-10 Jul. 2008), methane hydrates tend to increase their concentration if the thermodynamic cycle reported in FIG. 3 of the enclosed drawings is followed.

In practice, the reaction occurs in bulk in a batch reactor. After the “classical” formation (0-1 in FIG. 3) exploiting the supercooling energy, the reactor is repressurized (1-2) and then it is heated up to close to the equilibrium curve (2-3). At point 3 a further pressure drop is observed with associated exothermal peaks due to the hydrates formation at the reactor temperature (Tr), as reported in the experimental diagram of the enclosed FIG. 4. The equilibrium curve is followed, and then the cycle (1-2-3-1) is repeated. By operating in this manner the methane hydrate reaches a concentration of above 90%.

The same cycle has also been applied to hydrates of sour and hydrophilic molecules such as CO₂ and H₂S, and no reformation effects (as for methane) have been noted in conditions close to equilibrium.

### EXAMPLE 2

### Separation of Sour Gases by Controlled Dissociation in Conditions Close to Equilibrium

With reference to what set forth above, other experimental data show that during the controlled dissociation at 20 bar of a mixed hydrate (CO₂/CH₄) the CO₂ hydrates have a dissociation rate higher than the methane hydrates, and that an enrichment in CH₄ hydrates in the solid phase, with respect to CO₂ hydrates, has been noted (Rovetto L. J., Dec S. F., Koh C. A., Sloan E. D. Jr., NMR studies on CH₄+CO₂ binary gas hydrates dissociation behavior; Proc. of 6^{th} Intl. Conf. on Gas Hydrates. Vancouver BC, Canada 6-10 Jul. 2008).

In this connection the following example shows a case where the peculiarity of methane hydrates to concentrate in thermodynamic conditions close to the equilibrium conditions is exploited. The procedure adopted is summarized, in order to assist in understanding it, in the block diagram of the enclosed FIG. 5.

Considering a gaseous mixture at the pressure of 9.5 MPa and having the average composition shown below:

| | | |
|---|---|---|
| Methane | CH₄ | 74% |
| Hydrogen sulfide | H₂S | 26% |

In a closed reactor at 20° C. containing water (15 t) 8000 Nm³ of the said gas mixture are introduced, and the procedure according to the invention is carried our as follows:
the contact between water and gas produces a mixed hydrate with average composition of 32% H₂S hydrates and 68% methane hydrates (1^{st} formation);
the remaining gas mainly consists of methane, which is extracted from the reaction chamber for being used (second block);
8000 Nm³ of the feed mixture are fed to the reaction chamber, thus reaching 9.5 MPa (third block);
by heating to a temperature close to the equilibrium curve and by applying the thermodynamic cycle previously described (Giavarini, Maccioni, 2008) only the methane component of the gas mixture is transformed in clathrates, thus obtaining a hydrate product having an average composition of 83% in CH₄ and 17% in H₂S (2^{nd} formation/fourth block);
the remaining gas is extracted, which is H₂S alone, at a 2.47 MPa, to feed it to the inertization process and to storage (fifth block);
then the reaction chamber is repressurized with the feed gas mixture, reaching the pressure of 9.5 MPa and the temperature of 20° C. (sixth block);
by heating again to a temperature close to the equilibrium curve and by applying the thermodynamic cycle previously described (3rd^{d} formation/seventh block) a mixed hydrate is obtained having a composition of 88% methane hydrates and 12% hydrogen sulfide hydrates;
the gas present in the reaction chamber, i.e. H₂S at 2.47 MPa, is extracted and sent to the inertization process and to storage (eighth block);
the remaining hydrate (88% methane and 12% H₂S) is depressurized to 0.1-0.3 MPa and kept at a temperature between −1° C. and −2° C. to allow for the dissociation of H₂S hydrates (ninth block); in these conditions, the dissociation rate of hydrates containing hydrogen sulfide is about three times the dissociation rate of methane hydrates: the final separation of hydrogen sulfide thus takes place at this stage;
H₂S is extracted and sent to the storage (tenth block);
once the dissociation of sour hydrates is over, the conditions are created to dissociate the remaining methane hydrates (temperatures above 0° C. and pressure 0.1 MPa) and to send the purified methane to use (eleventh block);
the reactor containing water is thus ready to start a new purification process.

### EXAMPLE 3

### Separation of Sour Gases by Controlled Dissociation in Conditions Close to Equilibrium Operating Under Constant Pressure

Taking into account the composition of the gaseous mixture of Example 2 it is possible to separate the sour fraction by operating a part of the process under constant pressure.

In this case the thermodynamic cycle is reduced to a point, located close to the equilibrium conditions. The process is thus rendered simpler, as shown in FIG. 6 of the enclosed drawings.

In a closed reactor at 20° C. containing water (15 t) 8000 Nm³ of the gas mixture of Example 2 is introduced, and the process of the invention takes place according to the following steps:
the contact between water and gas produces a mixed hydrate with an average composition of 32% H₂S hydrates and 68% methane hydrates (1^{st} formation);
the remaining gas mainly consists of methane, which is extracted from the reaction chamber to be used (second block);
the gas mixture feed at 9.5 MPa and 20° C. is fed again to the reaction chamber, maintaining the pressure constant during the hydrate formation, up to a conversion of water into hydrate close to 95%—in the free volume of the reaction chamber 4.9 MPa of H₂S are left (third and fourth blocks);
the gas present in the reaction chamber, H₂S at 4.9 MPa, is extracted and sent to the inertization process and to storage (fifth block);
the remaining hydrate (88% methane and 12% H₂S) is depressurized to 0.1-0.3 MPa and kept at a temperature between −1° C. and −2° C. to allow for the dissociation of H₂S hydrates (sixth block); in these conditions, the dissociation rate of hydrates containing hydrogen sulfide is about three times the dissociation rate of methane hydrates: the final separation of hydrogen sulfide thus takes place at this stage;
H₂S is extracted and sent to the storage (seventh block);
once the dissociation of sour hydrates is over, the conditions are created to dissociate the remaining methane hydrates (temperatures above 0° C. and pressure 0.1 MPa) and to send the purified methane to use (eighth block);

The present invention has been disclosed with particular reference to some specific embodiments thereof, but it should be understood that modifications and changes may be made by the persons skilled in the art without departing from the scope of the invention as defined in the appended claims.

1. A process for purifying-sweetening natural gas through the controlled dissociation of the corresponding hydrates, which process comprises, in a sequence, the following steps:
a) forming hydrates of a natural gas, having concentrations of H₂S and CO₂ of from 10 ppm to 40% by volume, in a reactor and with the addition of water, if not already present in the feedstock, to obtain a first separation step during the formation of the said hydrates;
b) downloading from said reactor and separating the gas remaining from step a) which did not form hydrates;
c) purifying the hydrates formed in the previous steps through dissociation of the H₂S hydrates under pressure conditions above 0.1 MPa and at temperatures comprised between 0° C. and −5° C., to obtain a second separation step during the dissociation of the said hydrates formed in step a);
d) downloading the gas produced by the controlled dissociation of step c), enriched in H₂S;
e) obtaining fast dissociation of the hydrates remaining from step d) containing hydrocarbon compounds.

2. A process according to claim 1, also comprising, after the said step e), the following step:
f) recovering the reaction water and recycling it for another sequence of the procedure of hydrates formation from natural gas.

3. A process according to claim 1, wherein the said step a) of hydrates formation is carried out in a batch reactor in the presence of water or with water in the feedstock.

4. A process according to claim 1, also comprising a preliminary procedure of “re-formation-concentration” of methane hydrates in the solid phase by carrying out a thermodynamic cycle close to the equilibrium curve, with venting of the non-reacted sour gas downstream the said “re-formation-concentration” procedure comprising, after the steps a) and b), the following steps:
A. forming hydrates of a natural gas, having concentrations of H₂S and CO₂ of from 10 ppm to 40% by volume, in a reactor containing therein an already formed hydrate, under pressures and temperatures close to the equilibrium pressure and temperature, to obtain a methane-enriched mixed hydrate and, possibly, light hydrocarbons, and a remaining gas consisting of H₂S and CO₂;
B. downloading from said reactor and separating the remaining gas from step A) which did not form hydrates, consisting of H₂S and CO₂;
the remainder of the process being analogous to steps c) and following as defined in claim 1.

5. A process according to claim 4, wherein the said steps A) and B) are cyclically repeated two or more times.

6. A process according to claim 4, wherein the said “reformation-concentration” procedure is carried out under constant pressure with continuous hydrate formation.

7. A process according to claim 1, wherein conditioning agents suitable to favour the hydrates formation are mixed in the process reaction water, said agents being selected from the group consisting of quaternary ammonium salts, phosphonium salts, mixtures of clayey aggregates containing kaolin and montmorrillonite.

8. A process according to claim 1, wherein in the reaction water coformer agents are added, suitable to favour the hydrates formation process.

9. A process according to claim 8, wherein the said coformer is tetrahydrofurane and/or cyclopentane.

10. A process according to claim 1, wherein in the reaction water other compounds are added, suitable to interfere with the hydrogen bond, selected from the group consisting of glycols and alcohols.

11. A process according to claim 1, wherein, in order to assure continuity of the process, two or more reactors working in parallel are used.
